(19) United States
(12) Patent Application Publication
(10) Pub. No.: US 2015/0014411 A1
(43) Pub. Date: Jan. 15, 2015

(54) TRANSACTION CARD FOR WORKFLOW EXECUTION

(71) Applicant: XEROX CORPORATION, Norwalk, CT (US)

(72) Inventors: Chithralekha Balamurugan, Pondicherry (IN); Nischal M Piratla, Hyderabad (IN)

(21) Appl. No.: 13/938,259

(22) Filed: Jul. 10, 2013

(51) Int. Cl. G06Q 20/34; G06K 1/12

(52) U.S. Cl. CPC G06Q 20/355; G06K 1/12
USPC 235/380; 235/487; 235/494

(57) ABSTRACT

Some embodiments include methods, and systems for providing a customized and/or personalized transaction card to a user. The method begins with receiving a transaction card at or by a terminal device. A user is allowed to automatically login to a user account at or otherwise relating to the terminal device. Upon logging in, at least one workflow that is registered by the user is retrieved and then displayed to the user for selection. The selected workflow is then received. In response to the user's selection, the corresponding workflow associated activity is automatically executed, without requiring the user to navigate through multiple screens.

### TECHNICAL FIELD

The presently disclosed embodiments relate to transaction cards for various business services, and more particularly, to smart cards for executing workflows.

### BACKGROUND

The related art includes various types of cards, e.g., cash cards, debit cards, credit cards, smart cards, etc., that are commonly used to facilitate POS (Point of Sale) transactions, ATM, Internet, mobile banking services, etc. Some of these cards are single purpose cards, but others are multipurpose cards. For example, credit cards and debit cards are only used for withdrawing money, depositing money, or obtaining account balance information, but smart cards are multi-purpose cards that can be used as stored value cards, credit cards, debit cards, calling cards, fuel cards, etc.

Users are typically required to navigate through multiple screens or menus in order to complete a service related activity with the above related art cards. For example, the user may need to select the required banking services, and provide the required details across different user interface screens until the service is invoked and accomplished. If user A wishes to transfer an amount X to user B, then user A needs to first login into user A's account, select the third party transactions, choose the beneficiary (i.e., a person to whom the amount X is to be transferred), enter the amount to be transferred, and then press the submit button to complete the process.

The user needs to spend a considerable amount of time and effort to perform this entire process. Further, this process may be complex in terms of understanding and remembering each step that needs to be performed in order to complete any activity or transaction, especially for users from rural areas. These cards are generally not useable with Multi-function devices (MFDs). Moreover, these cards are not able to provide users with customized or personalized services, and instead provide all types of services to all users.

### SUMMARY

Embodiments disclose a method for customizing and/or personalizing a transaction card for a user. The method includes receiving an input from a user related to at least one workflow to be registered. Then, at least one input value corresponding to the at least one workflow is received from the user. The at least one workflow is created by converting the received at least one input value into at least one instruction. Thereafter, a pattern corresponding to the at least one created workflow is created and finally the pattern is inscribed or stored on the transaction card.

Other embodiments disclose a method of enabling a user to perform an activity via a customized and/or personalized transaction card. The method includes receiving a transaction card at a terminal device, the transaction card includes a pre-defined pattern. Then the user is automatically allowed to login to an account that is associated with the user at the terminal device. Upon logging in, at least one workflow registered by the user is retrieved. Thereafter, the retrieved at least one workflow is displayed to the user for selection. After this, the workflow selected by the user is received. Finally, the activity corresponding to the selected workflow is automatically executed, without the user having to navigate through a sequence of screens.

Some embodiments disclose a method, the method includes pre-customizing a transaction card with a customization machine, prior to issuance to a user, by storing a pre-defined pattern on the card, wherein the pre-defined pattern corresponds to at least one workflow. The method further includes post-customizing the transaction card, upon connection of the transaction card to a terminal device, by allowing the user to change one or more input values associated with the at least one workflow at the time of execution.

Yet other embodiments disclose a system for optimizing interaction for a user while performing an activity. The system includes a transaction card, a terminal device in communication with the transaction card, and a server in communication with the terminal device. The transaction card is configured to: store a pre-defined pattern on the transaction card, the pre-defined pattern corresponds to at least one workflow and user credentials; allow the user to automatically login to an account associated with the user; and to enable the user to perform an activity corresponding to the at least one workflow through a single operation. The terminal device is configured to: receive the transaction card; retrieve the at least one workflow registered by the user, the at least one workflow being pre-configured with at least one input value; display the retrieved at least one workflow to the user for selection. The server is configured to automatically execute the selected workflow while obviating navigation through multiple accessible screens.

### BRIEF DESCRIPTION OF THE DRAWINGS

FIG. 1 is a schematic of an exemplary transaction card, according to an embodiment of the disclosure.

FIG. 2 is a flowchart for customizing and/or personalizing a transaction card for a user.

FIG. 3 is a flowchart for using the customized and personalized transaction card.

FIG. 4A is an exemplary screenshot displaying one or more workflows registered by the user.

FIG. 4B shows exemplary details displayed to the user before execution.

FIG. 4C shows an exemplary message that is displayed to the user.

FIG. 5 is a system diagram, according to one embodiment of the disclosure.

FIG. 6 is a block diagram illustrating interaction among various components, according to an exemplary embodiment.

### DETAILED DESCRIPTION

The following detailed description is provided with reference to the figures. Exemplary, and in some cases preferred, embodiments are described to illustrate the disclosure, not to limit its scope, which is defined by the claims. Those of ordinary skill in the art will recognize a number of equivalent variations in the description that follows.

### Definitions

Definitions of one or more terms included in this disclosure are provided below. Generally, a “transaction card” is the one that allows the user to perform transactions, such as withdrawing money, depositing money, transferring money, paying bills, performing calls, etc. In the context of the present disclosure, the “transaction card” is a device customized and personalized for a user such that the user can perform any operation or activity while reducing the number of screens through which the user needs to navigate. Thus, some embodiments obviate navigation through a large number of screens, and/or reduce the number of screens required. More particularly, the “transaction card” allows the user to execute steps or operations (“workflows”, discussed below) in a single shot.

The term “terminal device” refers to any device capable of processing data received from the “transaction card” and provides a desired output. Further, the “terminal device” is capable of displaying data along with functionalities of sending and receiving data. An exemplary terminal device is a “multi-function device” (MFD). The MFD is a device, such as a single device that offers a number of traditional functionalities, such as printing, copying, scanning, and/or faxing, for example. In the context of the disclosure, the “MFD” is configured to operate with the “transaction card”. The “MFD” is capable of sending and/or receiving data from the “transaction card” and other connected devices, such as a server. “Server” refers to any device capable of processing data/requests received from the “transaction card”, the “terminal device” or similar device. Particularly, the “server” executes the transactions without the user having to navigate through a sequence of screens. “Workflow” corresponds to a set of operations or tasks that generally are performed to complete any transaction, such as a banking transaction. Further, “workflow” includes steps, which may be performed by the “transaction card”, “the terminal device”, “server” or a combination of these, or may also include steps of requesting for inputs from a user or other devices. “Workflow registration” refers to a process of getting the “workflows” registered with a “server” (bank server for example) before they can be used.

### Overview

The conventional cards require a user to navigate through multiple screens or menus to complete any transactional activity, for example, transferring money, paying bills, paying EMIs, etc. Thus, some embodiments of the disclosure provide a customized and personalized card enabling a user to perform any transaction or activity, and yet obviate navigation through a large number of screens, and/or reduce the number of screens required. More particularly, some embodiments provided in this disclosure focus on customizing and personalizing a transaction card for a user; the activity of customizing and/or personalizing the card may be performed before issuing the card to the user and this is a pre-customizing activity. For example, this customization/personalization may be performed by an organization that issues the card to the user. During this process, a pre-defined pattern is inscribed or stored on the card that corresponds to one or more workflows. The transaction card is operable when connected to a terminal device, such as a multi-function device. Other embodiments disclose the use of the customized and/or personalized card by enabling the user to execute the workflows through a single operation. Additional embodiments focus on allowing the user to change any values associated with the workflows at the time of execution and this activity is called as post-customization.

For simplicity, various embodiments are disclosed in the context of banking. However, various other embodiments are intended to also be applied in other contexts, such as telecom, postal, healthcare, transportation, entertainment, security access control, etc.

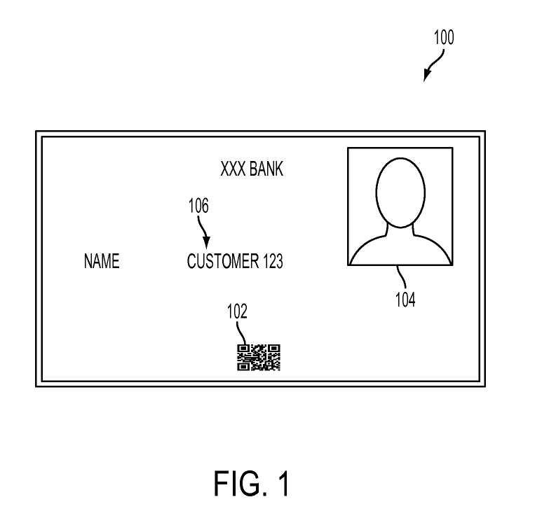

FIG. 1 illustrates a transaction card 100 according to one exemplary embodiment of the present disclosure. The transaction card 100 is in the form of a credit card-sized plastic card. However, other embodiments are directed to cards of any shape and size that include known, related art, and later developed technologies. The transaction card 100 may be a debit card, credit card, or the like. In an alternate embodiment, the transaction card may include a processor chip and a memory coupled to the processor.

Generally, the transaction card 100 is used as a credit card, debit card, authorization card for payment of a television bill, household utility pre-payment card, high security identification, access control card, public transport and/or public phone payment card, and/or any other card that relates to any type of transaction or other operation, financial or otherwise. In the context of the present disclosure, the disclosed transaction card 100 is customized or otherwise personalized for executing workflows such as banking workflows while obviating navigation through a large number of screens and/or reducing the number of screens required. The customization enables the workflow invocation and execution to occur quickly using customized input values for the workflows and/or by obtaining input values from the user during the workflow execution.

As shown, the transaction card 100 includes a photo 104 of the user, user name 106, and a pre-defined pattern 102 that corresponds to one or more workflows and/or user information. However, other embodiments include other and/or additional information/data.

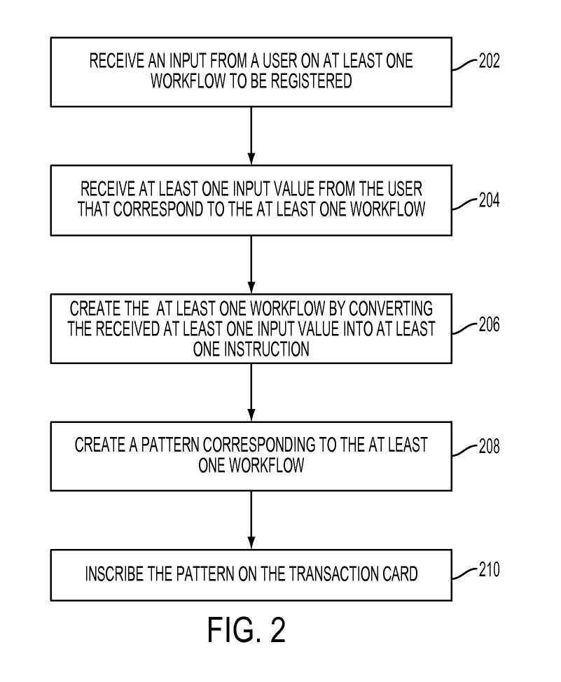

FIG. 2 is a flowchart of an exemplary embodiment for customizing and/or personalizing a transaction card. It may be beneficial for the process of customizing and personalizing the card to occur before issuing the card to a user, and/or be performed by a banking organization. However, other embodiments can perform these operations in a different order. Once the activity of customizing and/or personalizing the card is partially completed, substantially completed, or in some cases completed, the transaction card is issued to the user, such as upon the user opening an account with a banking organization. Alternatively, the card may be issued to the user upon receiving a request from the user. In some embodiments, an organization that issues the card may obtain information from or about the user prior to issuance. For example, in some embodiments, before issuing the transaction card, a representative of the issuing organization, such as a bank employee, may ask the user what kind of operations or activities the user generally performs. Those activities may include paying EMIs, paying phone bills, transferring money, etc. Each activity, which may include a series of steps to be performed, is defined as a workflow. However, other embodiments utilize alternative methods for obtaining information about the user. For example, in some embodiments, the transaction card may be issued to the user automatically by analyzing user banking services usage behavior. Other embodiments are intended to include or otherwise cover any useful or otherwise beneficial method for obtaining the user's information.

At 202, the method begins with receiving an input from a user relating to at least one workflow to be registered. Various examples of the workflows can be, but are not limited to, transferring money to a family member (e.g., son), paying a credit card bill, etc. Then, at 204, at least one input value, which is associated with the at least one workflow, is received from the user. For example, if the workflow is to transfer money to my son, then the input values may include an amount to be transferred, to whom it needs to be transferred, account details of son, a date of transferring the amount, and/or other relevant details.

After receiving the at least one input value, at 206, the input value is converted into at least one instruction to create the workflow. Particularly, the input value is input by an official of the issuing organization, such as a bank employee, through an application interface that is capable of generating workflow based on the specified information. The generated workflow is then linked to the account of the user. After the transaction card is customized and/or personalized, the registered workflows are activated and displayed to the user when the transaction card is in use.

The instructions may be in the form of simple statements and/or conditional statements. In accordance with conditional statements, the workflow will only be executed if the condition is met. For example, the simple statement may be in form of—Debit account ‘xxx’ with amount ‘yyy’ and credit account ‘aaa’ of bank ‘bbb’ with amount ‘yyy’, where ‘xxx’, ‘yyy’, ‘aaa’, ‘bbb’ are input values. In some embodiments, the input values may be fixed at the time of customizing the card, but in other embodiments, the values may be obtained from the user at the time of executing the workflow. In another example, the instructions may be as follows: If an account ‘xxx’ credited with amount ‘zzz’, from account ‘nnn’, then debit account ‘xxx’ with amount ‘yyy’ and credit account ‘aaa’ of bank ‘bbb’ with amount ‘yyy’. Here, the debit and credit steps will only be executed as mentioned above upon the account ‘xxx’ being credited with the amount ‘zzz’.

Then, at 208 a pattern is created corresponding to the at least one created workflow. The pattern may be in the form a bar code, QR code or the like. Finally, the pattern is inscribed on the transaction card at 210. Upon connection with a terminal device, the pattern is read, identified, and subsequently corresponding workflows are retrieved and then displayed to the user.

The QR code is a Quick Response code that includes workflow information as well as information required for authenticating the user, user credentials, for example. Each time any changes to the workflows are made, then the QR code may also be changed, and a new card may need to be issued to the user. In other embodiments, a web link may be embedded in the QR code. When scanning the card, the terminal device may take the user to the web page that stores workflow information, and all of the registered workflows may be displayed to the user accordingly. Specifically, upon scanning the transaction card, the terminal device reads the QR code, and translates the code into text, wherein the text is a hyper link. The link corresponds to a web page for the user's account, including all relevant details, such as registered workflows. An official of the issuing organization, such as a bank employee, may make any necessary changes in the displayed workflow. In some embodiments, the workflow is updated in a manner that is similar to updating a web page, such as by using known, related art, and/or later developed techniques. In instances, where the QR code includes a web link, only the web page is updated and the QR code remains the same, thus, issuing a new card to the user may not be required.

Moreover, the customized workflow may be deleted upon receiving a request from a user. For example, if the user son's is no longer studying at school A, then it may be beneficial for the user to have this workflow deleted, which can be performed by the bank employee. Similarly, a customized workflow may be modified. In one example that involves a workflow to pay EMI every month, the user may want the EMI amount to be modified and this can be done at the time of executing the workflow. Any workflow can be added to the pre-defined pattern stored on the transaction card in a similar manner. The workflow deletion, modification, and/or addition can be performed any time after issuance of the card.

In some embodiments, different workflows may be customized for different users according to their specific needs. For example, one user may want a workflow to pay tuition fees for his son studying at school A, whereas another user may want a workflow to pay an EMI of a purchased item.

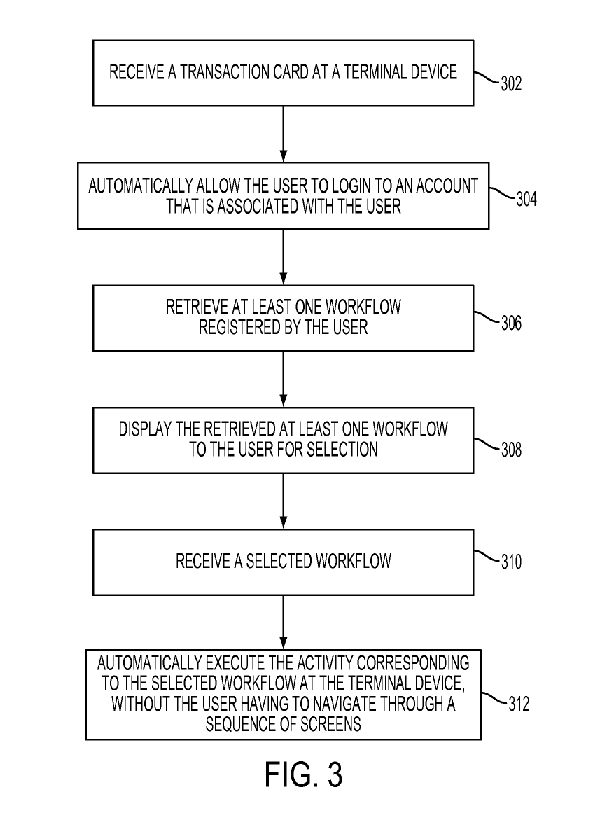

FIG. 3 is a flowchart for providing a customized transaction card to a user and for using the card once it is provided to the user, according to one embodiment of the disclosure.

At 302, a transaction card is received on or at a terminal device. For example, the user may swipe the transaction card into a reader of the terminal device. Alternatively, the user may scan the transaction card using the terminal device. In some cases, the transaction card may be connected to the terminal device through radio frequency signals, i.e., without requiring any physical connection. Once connected, the terminal device reads the pattern stored on the card.

At 304, the user is automatically allowed to login to a user account at the terminal device. Upon logging in, at 306, at least one workflow that is registered by the user is retrieved. The workflows may be retrieved from a memory of the terminal device, or may be retrieved from a server connected to the terminal device. Once retrieved, the registered workflows are displayed to the user for selection at 308.

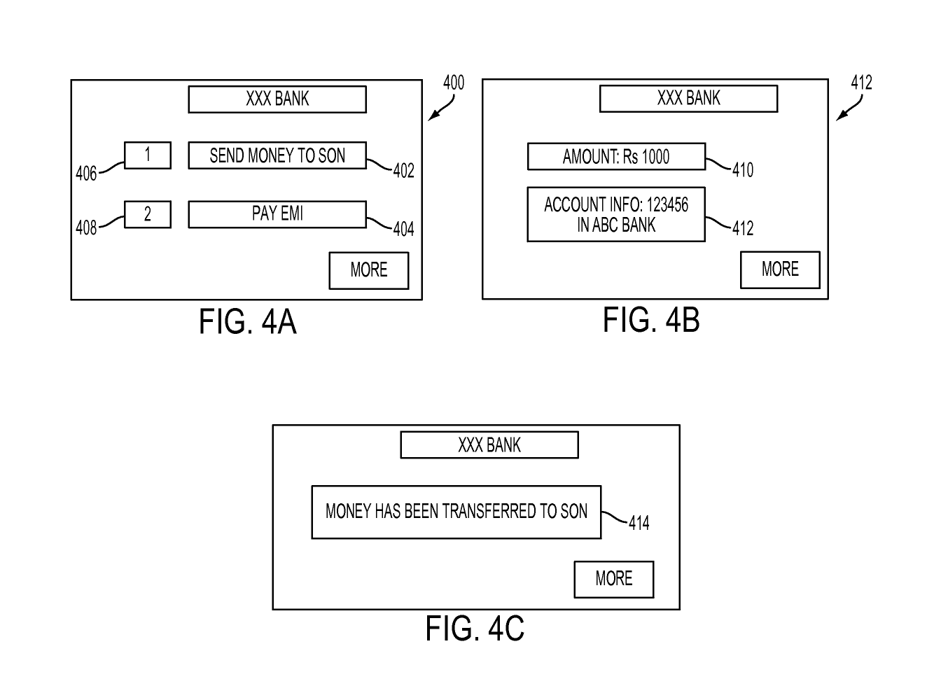

One or more workflows registered by the user, e.g., Transfer Money to Son (402), and Pay EMI (404) are shown in the snapshot 400. FIG. 4A only shows two workflows, but embodiments are intended to cover or otherwise include any number of workflows that can be registered by the user and displayed accordingly. In the shown exemplary embodiment, an icon 406, 408 is defined for each workflow. The icons 406, 408 can be touched or clicked during execution. For example, if the user wishes to transfer money to the user's son, then the user may simply touch the icon 406 and the workflow 402 is executed. In some embodiments, before executing the selected workflow, for example workflow 402, details associated with the selected workflow such as account details 412, amount 410, and other details are displayed to the user as shown in FIG. 4B. The user can select any of the shown details and modifies the values before executing the workflow. Considering the tuition fee has been increased from Rs 1000 to 2000, in such cases, the user may select the block 410 and may modify the value as desired.

The workflows and corresponding text shown in FIG. 4A are merely provided for exemplary purposes and are not intended as limiting. Any number and type of workflows may be displayed, such as via a combination of any type of text and/or images.

The user selects a displayed workflow, and the selection of the workflow is received at 310. In response to the selected workflow, at least one instruction associated with the selected workflow is retrieved. The at least one instruction is pre-configured with input values. In some embodiments, the input values are obtained dynamically at the time of execution. For example, the input values may be obtained from the user, or may be obtained from various connected devices. As a next step, the corresponding workflow or instructions are executed at a server automatically without requiring the user to navigate through a large number of screens, and in some embodiments multiple execution screens, at 312. Some embodiments of the present disclosure thereby enable the user to perform any transaction with a single operation, without requiring the user to expend time and effort to navigate through multiple steps. Once the workflow is executed, an exemplary message 414 may be displayed to the user, as illustrated in FIG. 4C.

If all the input values are defined to be static, then the user just needs to press the icon 406 for execution. Otherwise, additional boxes are displayed to obtain the required input values. In the case of a dynamic value, the terminal device analyzes the input value received from the user every time, and if that value is repeatedly determined to be the same, then that input value may be displayed as a default value to the user for that corresponding input value.

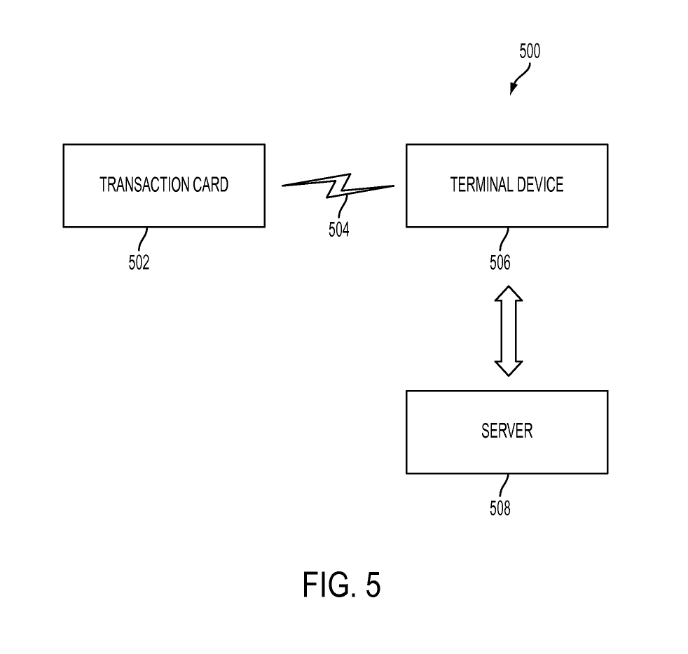

FIG. 5 illustrates an exemplary system 500 for executing one or more workflows, such as banking workflows. The system 500 includes a transaction card 502, which becomes operational or activated if connected to a terminal device 506. The system further includes a server 508 in communication with the terminal device 506. The transaction card 502 and the terminal device 506 communicate with each other using any known, related art, and/or later developed communication medium 504. In one example, the terminal device 506 may be a multi-function device, but the terminal device 506 can be any device capable of operating with the transaction card 502 to perform the desired task.

The transaction card 502 may be a contact card or may be a contactless card. In the case of a contact card, the card 502 includes physical contact points disposed on the surface of the card body for establishing connection between the transaction card 502 and the terminal device 506. In such instances, the transaction card 502 physically contacts the terminal device 506. In other cases, the transaction card 502 establishes a connection with the terminal device 506 using radio frequency signals. To this end, the transaction card 502 includes a radio frequency component that enables communication between the transaction card 502 and the terminal device 506 without physically contacting the transaction card. The communication medium 504 between the transaction card 502 and terminal device 506 may involve a physical connection, wireless transmission, radio frequency signals, and/or any other known, related art or later developed technologies.

Initially, the user either swipes the transaction card 502 into the terminal device 506 or scans the transaction card 502 using the terminal device 506. Upon receiving the transaction card 502, the terminal device 506 reads the pre-defined pattern stored on the card 502. Based on the pre-defined pattern, the terminal device 506 allows the user to automatically login to a user account by communicating with the server 508. Upon logging in, the terminal device 506 retrieves all of the workflows, which are registered by the user, and subsequently displays the retrieved workflows to the user. Subsequently, the user selects a workflow that the user wishes to execute. Then, in accordance with some embodiments, the server 508 executes the selected workflow without requiring the user to navigate through multiple screens or other prompts. In this way, the user can complete any transaction without providing input(s) multiple times or otherwise navigating through multiple steps.

In an embodiment, the transaction card 502 can be implemented as an app on a smart device that has a pre-defined pattern or code, wherein the app helps the user initiating the transaction. In this embodiment, the user launches the app on the smart device and then the smart device scans the pattern using its camera and transfers the pre-defined pattern or code to the terminal device 506. Once the pattern is transferred, the terminal device 506 retrieves the required details such as user credentials, and registered workflows and allows the user to execute the workflows as discussed above in detail. Various ways through the smart device can communicate with the terminal device 506 may be blue tooth, wi-fi, or the like. In another embodiment, the bank may send the pre-defined pattern or code to a smart device of the user. The user can then use that code to initiate the transaction with a bank server. Upon receiving the code from the user, the bank server retrieves the registered workflows and displays those to the user on his smart device. As a next step, the user can select one of the displayed workflows and complete the transaction through his smart device. In this manner, the user can perform the entire transaction without having the MFD or equivalent device.

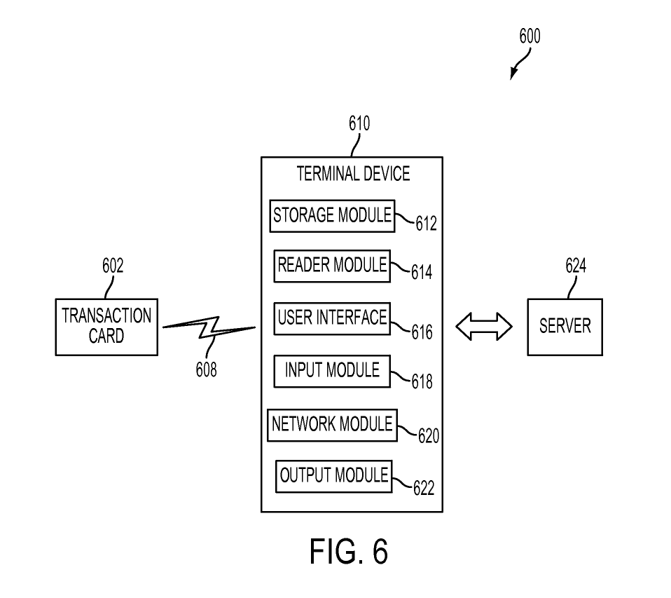

FIG. 6 is a schematic illustrating various components of a system 600 according to one embodiment of the disclosure. The system 600 includes a transaction card 602 and a terminal device 610. The terminal device 610 includes a reader module 614, a storage module 612, a user interface 616, an input module 618, a network module 620, and an output module 622. A communication medium 608 enables communication between the transaction card 602 and the terminal device 610. The terminal device 610 communicates with the server 624 through the network (although not shown). Various examples of the network may be, but not limited to, a local area network (LAN), wide area network (WAN), world wide web (www), public switched telephone network (PSTN), cellular telephone network, or any other terrestrial or satellite network appropriate.

### Transaction Card

As discussed above, the transaction card 602 may be a contact card or a contactless card. However, embodiments are intended to cover or otherwise include any type of card that may be useful or otherwise beneficial, involving any known, related art and/or later developed technologies.

The transaction card 602 stores a pre-defined pattern that corresponds to one or more registered workflows and/or user information. The pre-defined pattern is read by the terminal device 610 as discussed above.

### Terminal Device

A storage module 612 stores details of the user as well as workflow related data. For instance, the storage module 612 stores instructions associated with the workflows and corresponding pre-configured input values. Additionally, the storage module 612 may store any relevant information required or helpful for executing the workflows.

The reader module 614 receives and communicates with the transaction card 602, and in particular reads the pre-defined pattern inscribed on the card. Further, the reader module 614 may be a contact reader module that requires a physical connection to the transaction card 602, which is made by inserting the card 602 into the reader module 614. Alternatively, the reader module 614 may be a contactless module that operates wirelessly, such as via a radio frequency, and communicates when the card 602 is in proximity with the reader module 614.

Upon reading the pattern, one or more workflows registered by the user are displayed to the user through the user interface 616. The workflows are displayed to the user in a user understandable format, as shown in FIG. 4A. In some embodiments, the user interface 616 may be used to provide an input and/or display an output.

Then, through the input module 618, the user selects one of the displayed workflows. In one embodiment, the input may be provided using input device(s), such as a keyboard, mouse, display, user interface, touch pad, etc., and/or any other known, related art or later developed method or apparatus.

Upon selection, the terminal device 610 retrieves one or more instructions associated with the selected workflow, which include pre-defined input values. These instructions and pre-defined values are displayed to the user in the user understandable format for any modification. In case the user has made changes to the input values, the terminal device 610 communicates those values to the server 624.

The network module 620 connects the terminal device 610 to various network entities, such a server or other device, to perform any necessary operation. In the shown embodiment, the network module 620 connects the terminal device 610 to the server 624 for executing the selected workflows without requiring the user to navigate through multiple screens.

Finally, the output module 622 outputs the completed workflow activity to the user. In some embodiments, the output module 622 can provide various types of outputs to the user, including but not limited to a document, display, etc. For example, the output module 622 may display a message to the user, e.g., an amount 1234 has been successfully transferred.

In some embodiments, the terminal device 610 disclosed above can be a single unit that performs one or more of the above disclosed functionalities. However, the terminal device 610 does not have to be a multi-function device, and embodiments are intended to enable the transaction card 602 to interface with any device that has the ability to scan and translate the stored pattern or code into workflow executions, and to then execute them such as via connection(s) to other required devices.

Additionally, the components/modules of each of the terminal device 610 can be internally connected to each other via any known, related art and/or later developed communication bus. In other words, any communication bus can be used to enable these components to perform their respective functions and to interact with each other to enable the system to function appropriately.

The present disclosure focuses on customizing and personalizing a transaction card for a user according to the user's requirements, and also providing the customized and personalized card to the user. The transaction card includes pre-programmed workflow information, which reduces or obviates manual transaction(s), i.e., navigating through a large number of, and in some cases, multiple screens. The disclosure enables the user to select any of the workflows and execute the selected workflow, which saves a significant amount of time and effort of the user. Further, the disclosed card focuses on security by storing workflow related information in a machine-readable pattern format. Moreover, the card simplifies, enhances, and in some cases optimizes, user interaction with the terminal device. Additionally, the card provides fast access to various services through the terminal device. The card also reduces the amount of time and effort that an official of the issuing organization needs to spend in assisting a user.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A method for customizing and/or personalizing a transaction card for a user, the method comprising:
receiving an input from a user related to at least one workflow to be registered;
receiving at least one input value from the user that corresponds to the at least one workflow;
creating the at least one workflow by converting the received input value into at least one instruction;
creating a pattern corresponding to the at least one created workflow; and
inscribing the pattern on the transaction card.

2. The method of claim 1 further comprising associating the pattern with the at least one created workflow.

3. The method of claim 1, wherein the at least one instruction is in a machine-readable format.

4. The method of claim 1, wherein the at least one workflow is re-customizable.

5. The method of claim 1, wherein the at least one workflow corresponds to bank related transaction.

6. The method of claim 1, wherein the pattern is in the form of a bar code or a QR code.

7. The method of claim 1, wherein the pattern is identified when the transaction card is connected to a terminal device.

8. A method of enabling a user to perform an activity via a customized and/or personalized transaction card, comprising:
receiving a transaction card at a terminal device, the transaction card includes a pre-defined pattern;
automatically allowing the user to login to an account that is associated with the user at the terminal device;
retrieving at least one workflow registered by the user;
displaying the retrieved at least one workflow to the user for selection;
receiving a selected workflow; and
automatically executing the activity corresponding to the selected workflow, without the user having to navigate through a sequence of screens.

9. The method of claim 8 further comprising reading the pre-defined pattern inscribed on the transaction card.

10. The method of claim 8 further comprising retrieving information associated with the pre-defined pattern.

11. The method of claim 10 further comprising retrieving at least one instruction associated with the selected workflow.

12. The method of claim 11 further comprising executing the retrieved instruction.

13. The method of claim 12, wherein the retrieved instruction includes one or more pre-defined input values.

14. The method of claim 12 further comprising obtaining at least one input value dynamically while executing the retrieved instruction.

15. The method of claim 8, wherein the at least one workflow is displayed to the user in a user understandable format.

16. The method of claim 8 further comprising displaying details associated with the selected workflow before executing.

17. A method, comprising:
pre-customizing a transaction card with a customization machine, prior to issuance to a user, by storing a pre-defined pattern on the card, the pre-defined pattern corresponds to at least one workflow; and
post-customizing the transaction card, upon connection of the transaction card to a terminal device, by allowing the user to change one or more input values associated with the at least one workflow at the time of execution.

18. A system for optimizing interaction for a user while performing a transaction, comprising:
a transaction card configured to:
store a pre-defined pattern on the transaction card, the pre-defined pattern corresponds to at least one workflow and user credentials;
allow the user to automatically login to an account associated with the user; and
enable the user to perform the transaction corresponding to the at least one workflow through a single operation;
a terminal device for communication with the transaction card by being configured to:
receive the transaction card;
retrieve the at least one workflow registered by the user, the at least one workflow being pre-configured with at least one input value;
display the retrieved at least one workflow to the user for selection; and
a server in communication with the terminal device, being configured to:
automatically execute the selected workflow while obviating navigation through multiple user accessible screens.

19. The system of claim 18, wherein the transaction card is one of a swiping card and a scanning card.

20. The system of claim 18, wherein the terminal device is a multi-function device.

21. The system of claim 18, wherein the terminal device is connected to the server over a network.
